(19) United States
(12) Patent Application Publication
(10) Pub. No.: US 2025/0111240 A1
(43) Pub. Date: Apr. 3, 2025

(54) TEMPORAL EQUILIBRIUM ANALYSIS-BASED MULTI-AGENT MULTI-TASK LAYERED METHOD FOR CONTINUOUS CONTROL

(71) Applicant: CHANGZHOU UNIVERSITY, Changzhou (CN)

(72) Inventors: Chenyang ZHU, Changzhou City (CN); Shoukun XU, Changzhou City (CN); Zhengwei ZHU, Changzhou City (CN); Lin SHI, Changzhou City (CN); Kaibin CHU, Changzhou City (CN); Yunxin XIE, Changzhou City (CN)

(21) Appl. No.: 18/560,859

(22) PCT Filed: Jul. 17, 2023
(86) PCT No.: PCT/CN2023/107655

§ 371 Date: Nov. 14, 2023

(30) Foreign Application Priority Data
Sep. 30, 2022 (CN) 202211210483.9

(51) Int. Cl. G06N 3/092; G06N 3/04

(52) U.S. Cl. CPC G06N 3/092; G06N 3/04

(57) ABSTRACT

The present invention discloses a temporal equilibrium analysis-based multi-agent multi-task continuous control method, comprising steps: constructing a multi-agent multi-task game model based on temporal logic, performing temporal equilibrium analysis, and synthesizing multi-agent top-level control policies; constructing a specification auto-completion mechanism, improving dependent task specification by adding environment assumptions; constructing connection mechanism between the top-level control policies and bottom-level deep deterministic policy gradient algorithms, and constructing multi-agent continuous task controllers based on the connection mechanism. The present invention captures the temporal attributes of tasks based on temporal logic, improves the interpretability and usability of system specification through specification completion, and generate top-level abstract task representations and apply them to the control of bottom-level continuous systems, solving the practical problems on multi-agent multi-task continuous control such as poor scalability, easy to fall into local optimality and sparse rewards.

### FIELD OF THE INVENTION

This invention relates to a multi-agent multi-task layered method for continuous, specifically relates to a temporal equilibrium analysis-based multi-agent multi-task layered continuous control method.

### BACKGROUND OF THE INVENTION

A multiple intelligent agent (multi-agent) system is a distributed computing system in which multiple agents interact with one another in the same environment through cooperation or competition to achieve specific goals and tasks to a maximum extent, currently being widely used in fields such as task scheduling, resource allocation, collaborative decision support, and autonomous operations under complex environments. As the interaction between multiple agents and the physical environment becomes increasingly intertwined, the complexity of continuous multi-task control problems also continues to grow. Linear temporal logic (LTL) is a formal language that can be used to describe a non-Markovian complex specification. Introducing LTL into multi-agent systems to design task specification allows for capturing the temporal attributes of the environment and tasks, expressing complex task constraints. In the case of multi-drone path planning. LTL can be used to describe task instructions, such as always avoiding certain obstacle areas (safety), touring and passing through specific areas according to an order (sequentiality), if passing through one area then arriving at another area (response), or eventually passing through a particular area (liveness). Temporal equilibrium analysis of LTL specification can generate top-level control policies for multi-agent systems, abstracting complex tasks into subtasks and solving them step-by-step. However, temporal equilibrium analysis has double-exponential time complexity, and becomes even more complex under imperfect information conditions. At the same time, learning subtasks often involve continuous state and action spaces. For instance, the state space of multiple drones can be continuous sensor signals, and the action space can be continuous motor commands. In recent years, policy-gradient based algorithms of reinforcement learning have gradually become a core research direction for the low-level continuous control of agents. However, applying policy-gradient based algorithms to continuous task control poses challenges such as sparse rewards, overestimation, and trapped in local optima, making the algorithm less scalable and unsuitable for large-scale multi-agent systems involving high-dimensional state and action spaces.

Known temporal equilibrium analysis has double exponential time complexity, and it becomes even more complex under imperfect information conditions. Additionally, learning subtasks usually involve continuous state and action spaces, where the state space is often continuous sensor signals, and the action space consists of continuous motor commands. The combination of continuous state and action spaces may lead to practical issues when using policy-gradient based algorithms for continuous control training, including slow convergence, susceptibility to local optima, sparse rewards, and sensitivity to parameters. These problems also result in limited scalability of the algorithm, making it unsuitable for large-scale multi-agent systems involving high-dimensional state and action spaces. Therefore, there is a need to address the technical challenge of how to conduct temporal equilibrium analysis to generate top-level abstract task representations and apply them to the control of low-level continuous systems.

### SUMMARY OF THE INVENTION

Invention objective: The objective of the present invention is to provide a temporal equilibrium analysis-based multi-agent multi-task layered continuous control method that can enhance the interpretability and usability of multi-agent system specification.

Technical solution: The control method of the present invention comprises the following steps:
S1, constructing a multi-agent multi-task game model based on temporal logic, performing temporal equilibrium analysis, and synthesizing multi-agent top-level control policies;
S2, constructing a specification auto-completion mechanism, improving dependent task specification by adding environment assumptions;
S3, constructing connection mechanism between the top-level control policies and bottom-level deep deterministic policy gradient algorithms, and constructing multi-agent continuous task controllers based on the connection mechanism.

Furthermore, the constructed multi-agent multi-task game model is:

$$𝒢 = 〈 Na , S , A , {S}_{0 ,} λ , {( {γ}_{i} )}_{i ∈ N} , ψ 〉$$

where, Na represents the agent set, S and A respectively represent the state set and action set of the game model, S₀ is the initial state, Tr∈S×\vec{A}→S represents the state transition function in which all agents in a single state s∈S transit to a next state by taking action set \vec{a}∈\vec{A}, \vec{A} represents a vector of the action sets of different agents; λ∈S→2^{AP} represents a labelling function from state to atomic proposition; (γᵢ)_{i∈N} represents the specification for each agent i; ψ represents the specification that needs to be completed by the overall system;

Constructing an infeasible region Rᵢ( [symbol] ) for each agent i, such that the agent i does not have tendency of deviating from the current policy set in the set in which Rᵢ( [symbol] ) is located, the infeasible region Rᵢ( [symbol] ) is expressed as follows:

$${R}_{i} ( q ) = \{ s \vert ∃ \vec{σ} \cdot ∀ {σ}_{i} ⇒ π ( s , ( {\vec{σ}}_{- i} , {σ}_{i} ) ) \text{\textbar ≠} {γ}_{i} \}$$

where, there exists a policy set \vec{σ} in Rᵢ( [symbol] ) such that all policies σᵢ and the combination of other policies (\vec{σ}₋ᵢ, σᵢ) of agent i cannot satisfy γᵢ. \vec{σ}₋ᵢ represents that the policy set does not include the policy combinations of the ith agent; “∃” represents “existence”; “ [symbol] ” represents “incompliance”.

Then computing ∧_{i∈L} Rᵢ( [symbol] ), determining whether there exists a trajectory It in the intersection that satisfies (ψ∧∧_{i∈W} γᵢ), and using model-checking method to generate the top-level control policy for each agent.

Furthermore, in step S2, the detailed steps of constructing the specification auto-completion mechanism are as follows:
S21, refining task specification by adding environment assumptions;
adding environment constraints Ψ of loser L by selecting ε∈E, automatically generate a new specification using an anti-policy mode, which is expressed as:

$${⋀}_{e = 1}^{m} GF {Ψ}_{e} ⋀ ε ⇒ {⋀}_{f = 1}^{n} GF {φ}_{f}$$

where, E is the environment constraint set;

The detailed steps of generating the new specification are as follows:
S211, computing policies of the negated form of the original specification which acts as policies of finite state automata format for systhesizing (∧ₑ₌₁^{m} GF Ψₑ)∧¬(∧_{f=1}ⁿ GF φ_{f}); G represents that the specification is always true from the current moment; F represents that the specification will be eventually true at certain moment in the future.
S212, designing a pattern on the finite state automata that satisfies the form of FG Ψₑ specification;
S213, generating a specification according to the generated pattern and perform negation;
S22, for a task of a first agent M⊆W which is dependent on a task of a second agent N⊆W, under the condition of temporal equilibrium, firstly computing policies for all agents through Rᵢ( [symbol] ), synthesizing the finite state automata format; then designing patterns which satisfy the form of FG Ψₑ based on policies and using the pattern to generate ε^{a′}; searching specification refinement set ε^{b} of all agents b∈M according to step S21;

Then determining whether all of the specification satisfy ε^{a′}⇒ε^{b}; if satisfied, completing the refinement of task specification with dependency; if not satisfied, iteratively constructing ε^{a′} and ε^{b} until the following formula are satisfied:

$$\{ \begin{matrix}{⋀}_{e = 1}^{m} GF {Ψ}_{e}^{k 1} ⇒ {⋀}_{f = 1}^{n} GF {φ}_{f}^{k 1} , k 1 ∈ N \\ {⋀}_{e = 1}^{m} GF {Ψ}_{e}^{k 2} ⇒ {⋀}_{f = 1}^{n} GF {φ}_{f}^{k 2} , k 2 ∈ M ⇒\end{matrix}$$

$$\{ \begin{matrix}{⋀}_{e = 1}^{m} GF {Ψ}_{e}^{k 1} ⇒ {⋀}_{f = 1}^{n} GF {φ}_{f}^{k 1} ⋀ {ε}^{k {1}^{′}} , k 1 ∈ N \\ {⋀}_{e = 1}^{m} GF {Ψ}_{3}^{k 2} ⋀ {ε}^{k 2} ⇒ {⋀}_{f = 1}^{n} GF {φ}_{f}^{k 2} , k 2 ∈ M \\ ∀ a , b \cdot a ∈ N ⋀ b ∈ M ⇒ ( {ε}^{{a}^{′}} ⇒ {ε}^{b} )\end{matrix}$$

Furthermore, in the case that new specification is generated, determining whether the specification of all agents are reasonable and realizable after adding environment assumptions:
if realizable, completing the refinement of specification;
if ∧ₑ₌₁^{m} GF Ψₑ∧ε is reasonable, but there are situations where the specification cannot be realized by the agent after adding environment assumptions, iteratively constructing ε′, such that ∧ₑ₌₁^{m} GF Ψₑ∧ε∧ε′ can be realized.

Furthermore, in step S3, the detailed steps of constructing the connection mechanism between the top-level control policies and bottom-level deep deterministic policy gradient algorithms, and constructing multi-agent continuous task controllers based on the connection mechanism are as follows:
S31, according to temporal equilibrium analysis, acquiring policy σᵢ<Uᵢ, uᵢ⁰, Fᵢ, ACᵢ, δᵢ^{u}, δᵢ^{a}>of each agent in the game model, expanding the acquired policy as ηᵢ=<Uᵢ, uᵢ⁰, Fᵢ, ACᵢ, δᵢ^{u}, δᵢ^{r}>, where δᵢ^{r}∈Uᵢ×2^{AP}→R, and using it as a reward function in the expanded Markov decision process in a multi-agent environment; the expression of the expanded Markov decision process in a multi-agent environment is as follows:

$$T = 〈 Na , P , Q , h , ζ , ℒ , {〈 {η}_{i} 〉}_{i ∈ N} 〉$$

where, Na represents the agent set, P and Q respectively represent the environment states and action set taken by the multi-agent, h represents probability of state transition; ζ represents attenuation coefficient of T; [symbol] ∈P×Q×P→2^{AP} represents labelling function for state transition to atomic propositions, ηᵢ represents benefit that the environment obtains when adopting policy of agent i, transferring to p′∈P after agent i taking action q∈Q in p∈P, its state on ηᵢ will also transfer from u∈Uᵢ∪Fᵢ to u′=δᵢ^{u}(u, [symbol] (p, q, p′)) and obtain the reward δᵢ^{r}(u, [symbol] (p, q, p′)); “<>” represents a tuple, “∪” represents a union;
S32, expanding ηᵢ to Markov decision process format with the attenuation function ζᵣ determined by the state transition, and initializing all δᵢ^{r}, so that δᵢ^{r} is 0 when δᵢ^{u}(u, [symbol] (p, q, p′))∉F; δᵢ^{r} is 1 when δᵢ^{u}(u, [symbol] (p, q, p′))∈F;

Then determining the value function v(u)* of each state through the value iteration method, and the converged v(u)* is added to the reward function as a potential energy function, so the reward function r(p, q, p′) of T is expressed as follows:

$${r}^{′} ( p , q , {p}^{′} ) = r ( p , q , {p}^{′} ) + {ζ}_{r} ( {v ( {δ}_{i}^{u} ( u , ℒ ( p , q , {p}^{′} ) ) )}^{*} ) - {v ( u )}^{*}$$

S33, each agent i has an action network μ(p|θᵢ) with parameters θ, and shares an evaluation network Q(p, \vec{q}|ω, α, β) with parameters ω; constructing a loss function J(ω) for the evaluation network parameter ω, and updating the network according to the gradient backpropagation of the network. The expression of the loss function J(ω) is as follows:

$$J ( ω ) = \frac{1}{d} {\sum }_{t = 1}^{d} {( {r}_{t} + ζ {Q}^{′} ( {p}_{t + 1} , \vec{{q}_{t + 1}} , + ϵ \vert {ω}^{′} , {α}^{′} , {β}^{′} ) - Q ( {p}_{t} , \vec{{q}_{t}} \vert ω , α , β ) )}^{2}$$

where, rₜ is the reward value computed in step S32, Q(p, \vec{q}|ω, α, β)=A(p, \vec{q}|ω, α)+V(p|ω,β), A(p, \vec{q}|ω, α) and V(p|107 , β) are designed as fully connected layer networks to evaluate the state value and action advantage respectively. α and β are the parameters of the two networks respectively; d V(p|ω, β) is randomly sampled data from experience playback buffer data set D;

Finally, soft-updating the target evaluation network parameter and action network parameters respectively according to the evaluation network parameters ω and action network parameters θᵢ.

Furthermore, when the hetero-policy algorithm is used for gradient update, estimating the expected value of [symbol] Q·∇_{θ}_{ᵢ}μ according to the Monte Carlo method, and substituting the randomly sampled data into the following formula to perform unbiased estimation:

$${∇}_{{θ}_{i}} J ( {θ}_{i} ) \approx \frac{1}{d} {\sum }_{t = 1}^{d} {∇}_{{q}_{i}^{t}} Q ( {p}_{t} , \vec{{q}_{t}} \vert ω ) {∇}_{{θ}_{i}} μ ( {p}_{t} \vert {θ}_{i} )$$

where, ∇ represents the differential operator.

Compared with the existing technology, the present invention has the following significant effects:
1. Temporal logic can be used to capture the temporal attributes of the environment and tasks to express complex task constraints, such as passing through several areas in a certain order, that is, sequentiality; always avoiding certain obstacle areas, that is, safety; arriving at certain areas eventually then reach certain other areas, that is, response; and finally pass through a certain area, that is, liveness, which improves the temporal attribute of the task description.
2. The interpretability and usability of multi-agent system specification are improved by refining multi-agent task specification.
3. By connecting the top-level temporal equilibrium policy with the bottom-level deep deterministic policy gradient algorithm, the practical problems existing in current research such as poor scalability, easily trapped into local optima, and sparse rewards are solved.

### BRIEF DESCRIPTION OF THE DRAWINGS

FIG. 1 is a flowchart of present invention;

FIG. 2 is a flowchart of temporal equilibrium analysis;

FIG. 3 is a structural diagram of controller in one embodiment;

FIG. 4 shows a specification refinement process of the mobile UAV in one embodiment.

### DETAILED DESCRIPTION

The present invention will be further described in details below in conjunction with the description, drawings and specific embodiments.

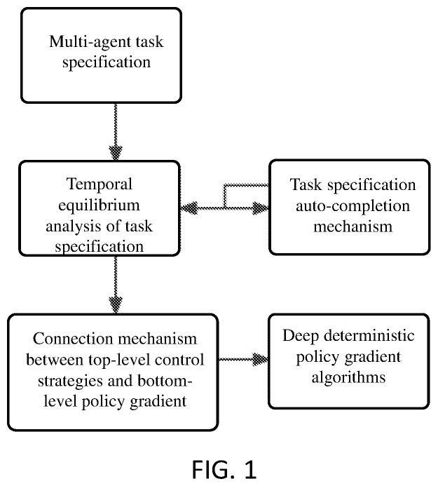

As shown in FIG. 1, the present invention includes the following steps:
Step 1: Constructing a multi-agent multi-task game model based on temporal logic, performing temporal equilibrium analysis and synthesizing a multi-agent top-level control policy.
Step 11, firstly building a multi-agent multi-task game model:

$$𝒢 = 〈 Na , S , A , {S}_{0} , Tr , λ , {( {γ}_{i} )}_{i ∈ N} , ψ 〉 \qquad ( 1 )$$

where, S and A respectively represent the state set and action set of the game model, S₀ is the initial state, Tr∈S×\vec{A}→S represents the state transition function in which all agents in a single state s∈S transit to a next state by taking action set \vec{a}∈\vec{A} (that is, one state corresponds to a collection of multiple agent actions, and then to the next state), \vec{A} represents a vector of the action sets of different agents; λ∈S→2^{AP} represents a labelling function from state set to atomic proposition (AP: Atomic Proposition); (γᵢ)_{i∈N} represents the specification for agent i; Na is the total number of agents (or agent set); φ represents the specification that needs to be completed by the overall system.

In order to capture the constraints of the environment on the system and the temporal attributes of the task, the specification γ of each agent and the specification φ that needs to be completed by the overall system are constructed in the form of ∧ₑ₌₁^{m} GF Ψₑ⇒∧_{f=1}ⁿ GF φ_{f}, where G and F are tense operators, G represents that from the current moment, the specification will always be true; F represents that the specification will be true at some time in the future (eventually); “∧” means “and”; m represents the number of assumed specification in the specification (≥ the number of former GF), n represents the number of guaranteed specification (≥ the number of subsequent GF); the value range of e is [1, m], and the value range of f is [1, n].

The policy σᵢ of agent i can be expressed as a finite state automata <Uᵢ, uᵢ⁰, Fᵢ, ACᵢ, δᵢ^{u}, δᵢ^{a}>, where Uᵢ⊆S is the state related to agent i; uᵢ⁰ is the initial state, Fᵢ is the final state; ACᵢ represents the action taken by agent i; δᵢ^{u}∈Uᵢ×2^{AP}→Uᵢ represents the state transition function; δᵢ^{a}∈Uᵢ→ACᵢ represents the action determination function.

According to the single state s and the policy set \vec{σ} of each agent, the specific trajectory π(s, \vec{σ}) of the game model can be determined. The tendency ρ(\vec{σ}) of the current policy set can be defined by judging whether the trajectory π(s, \vec{σ}) satisfies the specification γᵢ of the agent i. The policy set \vec{σ} of agent conforms to temporal equilibrium if and only if for all agents i and all their corresponding policies σᵢ, the tendency σ(\vec{σ})≥σ(σ₁, . . . , σᵢ, . . . , σ_{|Na|}) condition is satisfied.
Step 12, then building the temporal equilibrium analysis and policy synthesis model.

Constructing an infeasible region Rᵢ( [symbol] ) for each agent i so that the set where the agent i is located in Rᵢ( [symbol] ) has no tendency to deviate from the current policy set, the formula is as follows:

$${R}_{i} ( 𝒢 ) = \{ s \vert ∃ \vec{σ} \cdot ∀ {σ}_{i} ⇒ π ( s , ( {\vec{σ}}_{- i} , {σ}_{i} ) ) \text{\textbar ≠} {γ}_{i} \} \qquad ( 2 )$$

where, there is a policy set \vec{σ} in Rᵢ( [symbol] ), so that all policies σᵢ of agent i and other policy combinations (\vec{σ}₋ᵢ, σᵢ) cannot satisfy γᵢ; “∃” means “existence”; “ [symbol] ” means “incompliance”. \vec{σ}₋ᵢ represents the policy combination that does not include the i-th agent in the policy set.

Then computing ∧_{i∈L} Rᵢ( [symbol] ), determining whether there is a trajectory π in this intersection that satisfies (φ∧∧_{i∈W} γᵢ), and using the model-checking method to generate the top-level control policy for each agent i; W represents the set of agents that can satisfy the specification; L represents the set of agents that do not satisfy the specification, that is, the loser.
Step 2: Building a specification auto-completion mechanism and improve the dependent task specification by adding environment assumptions.
Step 21: Adding environment assumptions to refine the task specification.

In the temporal equilibrium policy, there is a problem that the specification of some losers cannot be realized. Therefore, the anti-policy automatically generates the mode of the newly introduced environment specification set E, and can add the environment specification Ψ of the loser L by selecting ε∈E, so that the new specification such as formula (3) can be realized.

$${⋀}_{e = 1}^{m} GF {Ψ}_{e} ⋀ ε ⇒ {⋀}_{f = 1}^{n} GF {φ}_{f} \qquad ( 3 )$$

wherein, the anti-policy mode firstly computing the policy in the negated form of the original specification, that is, synthesizing (∧ₑ₌₁^{m} GF Ψₑ)∧¬(∧_{f=1}ⁿ GF φ_{f}) policy in the form of a finite state automata.

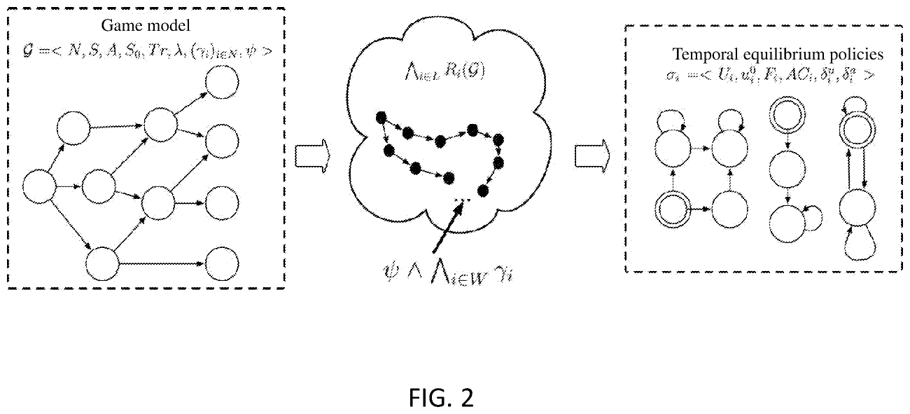

Then designing a mode on the finite state automata that satisfies the specification of the form FG Ψₑ, that is, using a depth-priority algorithm to find the strongly connected state of the finite state automata and use it as a mode that conforms to the specification; generating the specification through the generated mode and negating it, that is, a new specification is generated. In this case, it is determined whether the specification is reasonable and realizable for all agents after adding environment assumptions. If it is realizable, the refinement of the specification is completed; if ∧ₑ₌₁^{m} GF Ψ₃∧ε is reasonable, but there are situations where the agent's specification cannot be realized after adding environment assumptions, then iteratively constructing ε′ to make ∧ₑ₌₁^{m} GF Ψₑ∧ε∧ε′ realizable.
Step 22, refining the task specification with dependencies. For the tasks of the first agent set M⊆W which depend on the tasks of the second agent set N⊆W, under temporal equilibrium conditions, first computing through Rᵢ( [symbol] ) for the policies of all agents a∈N, synthesizing the form of a finite state automata; then designing a pattern that satisfies the form such as GF Ψₑ based on the policy and using this pattern to generate ε^{a′}; adopting the above method of adding environment assumptions to refine the task specification, find the refined set ε^{b} of all agents b∈M. Then judging whether all the specification satisfy ε^{a′}⇒ε^{b}. If so, completing the refinement of the task specification with dependencies; if not, iteratively constructing ε^{a′} and ε^{b} until the formula (4) is satisfied:

$$\{ \begin{matrix}{∧}_{e = 1}^{m} G F {Ψ}_{e}^{k 1} ⇒ {∧}_{f = 1}^{n} GF {φ}_{f}^{k 1} , k 1 ∈ N \\ {∧}_{e = 1}^{m} G F {Ψ}_{e}^{k 2} ⇒ {∧}_{f = 1}^{n} GF {φ}_{f}^{k 2} , k 2 ∈ M\end{matrix} ⇒ \{ \begin{matrix}{∧}_{e = 1}^{m} G F {Ψ}_{e}^{k 1} ⇒ {∧}_{f = 1}^{n} GF {φ}_{f}^{k 1} ∧ {ℰ}^{k ′} , k 1 ∈ N \\ {∧}_{e = 1}^{m} G F {Ψ}_{e}^{k 2} ∧ {ℰ}^{k} ⇒ {∧}_{f = 1}^{n} GF {φ}_{f}^{k 2} , k 2 ∈ M \\ ∀ a , b \cdot a ∈ N ∧ b ∈ M ⇒ ( {ℰ}^{a ′} ⇒ {ℰ}^{b} )\end{matrix} \qquad ( 4 )$$

where, ∧ₑ₌₁^{m} GF Ψₑ^{k1} represents the e-th assumed specification of agent k1 in the second agent set N; ∧_{f=1}ⁿ GF φ_{f}^{k1} represents the f-th guaranteed specification of agent k1 in the second agent set N; ∧ₑ₌₁^{m} GF Ψₑ^{k2} represents the e-th assumed specification of the agent k2 in the second agent set M; ∧_{f=1}ⁿ GF φ_{f}^{k2} represents the f-th guarantee rule of agent k2 in the second agent set M.
Step 3: Constructing a connection mechanism between the top-level control policy and the bottom-level deep deterministic policy gradient algorithm, and building a multi-agent continuous task controller based on this mechanism. The flow chart is shown in FIG. 2.
Step 31, according to the temporal equilibrium analysis, the policy of each agent in the game model σᵢ=<Uᵢ, uᵢ⁰, Fᵢ, ACᵢ, δᵢ^{u}, δᵢ^{a}> can be obtained, and it can be expanded to ηᵢ=<Uᵢ, uᵢ⁰, Fᵢ, ACᵢ, δᵢ^{u}, δᵢ^{r}>, where δᵢ^{r}∈Uᵢ×2^{AP}→R, and used as the reward function in the expanded Markov decision-making process in a multi-agent environment, as shown in formula (5):

$$T = < N a , P , Q , h , ζ , ℒ , < {η}_{i} {>}_{i ∈ N} > \qquad ( 5 )$$

where, Na represents the agent set; P and Q respectively represent sets of the state of the environment and the actions taken by multiple agents; h represents the probability of state transition; ζ represents the attenuation coefficient of [symbol] ∈P×Q×P→2^{AP} represents the labelling function of state transfer to atomic proposition; ηᵢ represents the benefit obtained by the environment when adopting the policy of agent i, that is, agent i transfers to p′∈P after taking action q∈Q in p∈P, which is on ηᵢ the state will also be transferred from u∈E Uᵢ∪Fᵢ to u′=δᵢ^{u}(u, [symbol] (p, q, p′)) and receive the reward δᵢ^{r}(u, [symbol] (p, q, p′)); “<>” represents a tuple, and “∪” represents a union.
Step 32, in order to compute the reward function r(p, q, p′) of T, expanding ηᵢ to the form of MDP (Markov decision process) with the attenuation function ζᵣ determined by the state transition, and initialize all δᵢ^{r}, such that when δᵢ^{u}(u, [symbol] (p, q, p′))∉F, δᵢ^{r} is 0; when δᵢ^{u}(u, [symbol] (p, q, p′))∈F, δᵢ^{r} is 1; then the value function v(u)* of each state is determined through the value iteration method, that is, each iteration selects maximum value of δᵢ^{r}(u, [symbol] (p, q, p′))+ζᵣ(v(δᵢ^{u} [symbol] u, [symbol] (p, q, p′) [symbol] )), and the converged v(u)* is added to the reward function as a potential energy function, as shown in formula (6):

$${r}^{′} ( p , q , {p}^{′} ) = r ( p , q , {p}^{′} ) + {ζ}_{r} ( {v ( {δ}_{i}^{u} ( u , ℒ ( p , q , {p}^{′} ) ) )}^{*} ) - {v ( u )}^{*} \qquad ( 6 )$$

Step 33, each agent i has an action network μ(p|θᵢ) with parameters θ, and shares an evaluation network Q(p, \vec{q}|ω, α, β) with parameters ω.

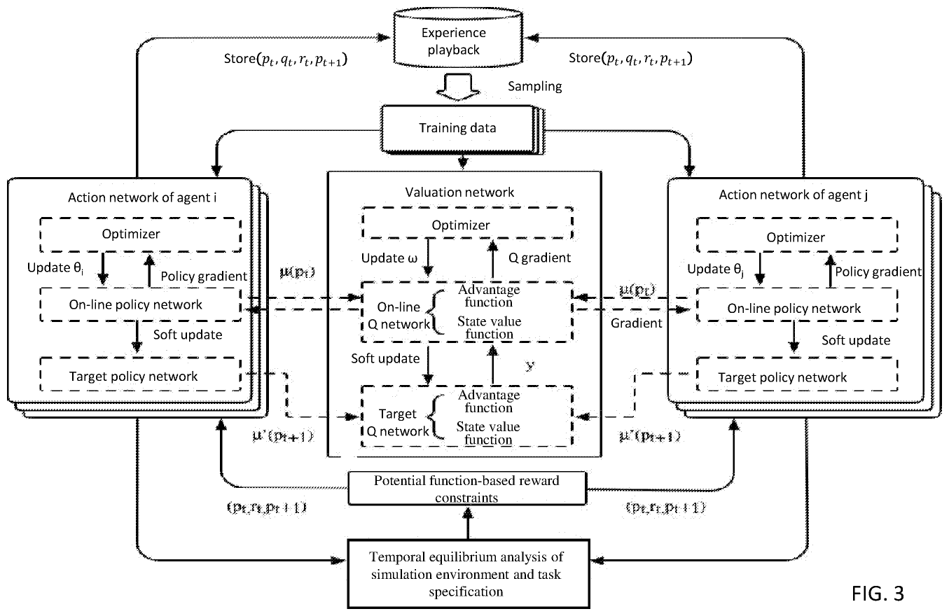

As shown in FIG. 3, firstly, the agent i selects actions to interact with the environment according to the behavioral policy, and the environment returns the corresponding reward according to the reward shaping method based on the temporal equilibrium policy, and stores this state transfer process in the experience playback buffer as a data set D; then randomly sample d data from the data set D as training data for the online policy network and the online Q network, which are used for the training of the action network and evaluation network. For evaluation network parameters ω, formula (7) is used as the loss function J(ω), and the network is updated according to the gradient backpropagation of the network.

$$J ( ω ) = \frac{1}{d} {\sum }_{t = 1}^{d} {( {r}_{t} + ζ {Q}^{′} ( {p}_{t + 1} , {{q}_{t + 1}}^{⟶} + ϵ \vert {ω}^{′} , {α}^{′} , {β}^{′} ) - Q ( {p}_{t} , \vec{{q}_{t}} \vert ω , α , β ) )}^{2} \qquad ( 7 )$$

where, rₜ is the reward value computed in step 32, Q(p, \vec{q}|ω, α, β)=A(p, \vec{q}|ω, α)+V(p|ω, β), A(p, \vec{q}|ω, α) and V(p|ω, β) are designed as fully connected layer networks to evaluate the state value and action advantage respectively. α and β are the parameters of the two networks respectively. A small amount of random noise ∈ that conforms to clip ( [symbol] (0, σ), −c, c) is added to the action for regularization to prevent overfitting. Wherein, clip is the truncation function, the truncation range is −c to c, and ∈˜ [symbol] (0, σ) is the noise that conforms to the normal distribution. where [symbol] (0, σ) is the normal distribution.

When using the hetero-policy algorithm for gradient update, estimate the expected value of [symbol] Q·V_{θ}_{ᵢ}μ according to the Monte Carlo method, that is, substitute the randomly sampled data into formula (8) for unbiased estimation:

$${∇}_{{θ}_{i}} J ( {θ}_{i} ) \approx \frac{1}{d} {\sum }_{t = 1}^{d} {∇}_{{q}_{i}^{t}} Q ( {p}_{t} , \vec{{q}_{t}} \vert ω ) {∇}_{{θ}_{i}} μ ( {p}_{t} \vert {θ}_{i} ) \qquad ( 8 )$$

where, ∇ represents the differential operator.

Finally, the target evaluation network parameters and action network parameters are soft updated respectively according to the evaluation network parameters ω and action network parameters θᵢ.

In this embodiment, a multi-UAV system collaborative path planning is used to complete the cyclic collection task as an example, and two UAVs are used as a case to explain the implementation steps of the present invention.

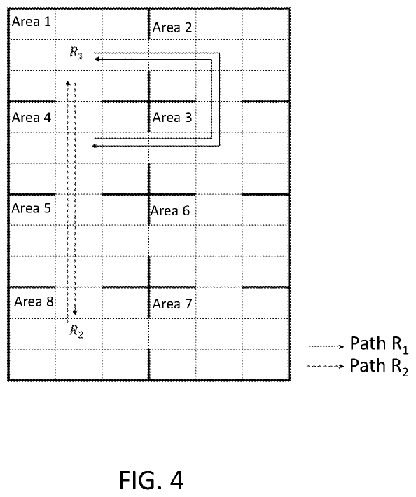

Firstly, the drones are in a space divided into 8 areas, and due to security setting they cannot be in the same area at the same time. Each drone can only stay in place or move to an adjacent cell. In this embodiment, Loc_{R}_{₁}, is used to represent the location of the drone Rᵢ. The initial state is Loc_{R}_{₁}=1, Loc_{R}_{₂}=8, that is, the drone R₁ is located in the area 1, UAV R₂ is located in area 8, as shown in FIG. 4. In this embodiment temporal logic is used to describe task specification, such as always avoiding certain obstacle areas (safety), touring and passing through certain areas in an order (sequentiality), and having to reach another area after passing through one area (response), will eventually pass through a certain area (liveness), etc., where the task specification of R₁ and R₂ are Φ₁ and Φ₂ respectively. Φ₁ only contains the initial position of R₁, path planning rules and the goal of visiting area 4 infinitely frequently. Φ₂ contains the initial position of R₂, path planning rules and the goal of infinitely frequent visits to area 4, while also needing to avoid collision with R₁. Since R₁ will continuously access area 4, the task of R₂ depends on the task of R₂. For R₁, a successful policy [symbol] ₁ is to move from the initial position to area 2, then move to area 3, and then move back and forth between area 4 and area 3, and the cycle continues like this.

The following is a set of R₁ specification described in temporal logic:
a) R₁ eventually only moves between areas 3 and 4: FG(Loc_{R}_{₁}∈{3,4});
b) R₁ is finally located in area 3 or 4: F(Loc_{R}_{₁}=3), F(Loc_{R}_{₁}=4);
c) R₁ is currently located in area 3, then the next step is to move to area 4. on the contrary, if it is located in area 4, then it moves to area 3: F(Loc_{R}_{₁}=3∧∘Loc_{R}_{₁}=4), F(Loc_{R}_{₁}=4∧◯Loc_{R}_{₁}=3), where “◯” represents the tense operator of the next state, and “∧” represents “AND”;
d) After R₁ is finally located in area 3 or 4, it will always be at this position: GF(Loc_{R}_{₁}=3), GF(Loc_{R}_{₁}=4);
e) The position of R₁ must be one of areas 1, 2, 3, and 4: G(Loc_{R}_{₁}∈{1,2,3,4});
f) R₁ must move to area 3 after area 2. If it is in area 3, it must then go to area 4: G(Loc_{R}_{₁}=2→◯Loc_{R}_{₁}=3), G(Loc_{R}_{₁}=3→◯Loc_{R}_{₁}=4).

Firstly, according to temporal equilibrium analysis, R₁ and R₂ cannot achieve temporal equilibrium. For example, policy of R₁ is to move from area 1 to target area 4 and stay there forever. In this case, task specification of R₂ can never be satisfied. Based on the specification refinement method of adding environment assumptions proposed in Algorithm 1,see Table 1 for details. The new environment specification for R₂ can be obtained, such as the following temporal logic specification.
g) R₁ should move out of target area 4 infinitely often: GF(Loc_{R}_{₁}≠4);
h) R₁ must not enter target area 4: G(Loc_{R}_{₁}≠4);
i) If R₁ is in target area 4, then needs to leave the area in the next step: G(Loc_{R}_{₁}=4→◯Loc_{R}_{₁}≠4).
wherein, g) and i) are judged to be reasonable assumptions through expert experience, so these two specification can be added to Φ₂ as environment assumptions, and added to Φ₁ as a guarantee. Finally, the top-level control policies of R₁ and R₂ can be obtained through temporal equilibrium analysis.

TABLE 1
pseudocode for specification refinement by adding
environment assumptions
Algorithm 1 : Pseudocode for specification refinement
by adding environment assumptions

```
Input: Λₑ₌₁^{m} GF Ψₑ ⇒ Λ_{f=1}ⁿ GF_{φf}, variable set U, search depth τ
Output: ε, such that Λₑ₌₁^{m} GF Ψₑ Λ ε ⇒ Λ_{f=1}ⁿ GF_{φf} is realizable
compute the anti-policy of Λₑ₌₁^{m} GF Ψₑ ⇒ Λ_{f=1}ⁿ
GF_{φf} and output the candidate queue
Q of the anti-policy
while Q is not empty
  ε := Q.DeQueue;
    if Λₑ₌₁^{m} GF Ψₑ Λ ε ⇒ Λ_{f=1}ⁿ GF_{φf} is realizable
      return ε;
  else
    if search depth< τ
      Compute anti-policy of Λₑ₌₁^{m} GF Ψₑ Λ ε ⇒ Λ_{f=1}ⁿ
      GF_{φf} and its candidate queue
Q_{new}
      For ε_{new} ∈ Q_{new} do
        Q.EnQueue(ε Λ ε_{new});
return no suitable refined specification being found
```

After the top-level control policy of the agent is obtained, it is applied to the continuous control of multiple drones. The continuous state space of multiple UAVs in this embodiment is as formula (9):

$$P = \{ {p}_{j} \vert {p}_{j} = [ {x}_{j} , {y}_{j} , {z}_{j} , {v}_{j} , {u}_{j} , {w}_{j} ] \} \qquad ( 9 )$$

where, j represents the j∈Nth UAV, xⱼ, yⱼ, zⱼ are the coordinates of the jth UAV in the spatial coordinate system, vⱼ, uⱼ, wⱼ are the speed of the jth UAV in the space. The state space of the drone is as follows:

$$Q = \{ {q}_{j} \vert {q}_{j} = [ {σ}_{j} , {φ}_{j} , {ω}_{j} ] \} \qquad ( 10 )$$

where, σ is yaw angle control, φ is pitch angle control, and ω is roll angle control.

After obtaining the top-level policy of temporal equilibrium, firstly computing the reward function r′(p, q, p′) with potential energy and apply it to Algorithm 2—Multi-agent deep deterministic policy gradient algorithm based on temporal equilibrium policy, see Table 2 for details, continuous control of multiple UAVs is performed.

TABLE 2
Pseudocode of multi-agent deep deterministic policy gradient
algorithm based on temporal equilibrium policy
Algorithm 2: Pseudocode of multi-agent deep deterministic policy
gradient algorithm based on temporal equilibrium policy

```
Input: number of samples for batch gradient descent d, state valuation
function network parameter α, action advantage function network
parameter β, maximum number of iterations of the target network Tₘₐₓ
Output: optimized action network parameter θ and valuation network
parameter ω
Randomly initialize action network μ(p|θᵢ) with parameters θᵢ, and
valuation network Q(p, \vec{q}|ω, α, β) with parameter ω;
Initialize weighting of target network;
For episode = 1 to episode_max do
  Initialize random process to explore noise and obtain initial state;
  For t = 1 to Tₘₐₓ do
    observe and measure current state pₜ through current action
network and cooperate with the segmented exploration noise
selection action \vec{qₜ};
    compute rewardrₜ according to r′(p, q, p′) and store
(pₜ, qₜ, rₜ, pₜ₊₁) in buffer D;
    extract d experiences from D, and update valuation network:
    $\begin{matrix}J ( ω ) = \frac{1}{d} {\sum }_{t = 1}^{d} ( {r}_{t} + ζ {Q}^{′} ( {p}_{t + 1} , {{q}_{t + 1}}^{⟶} + ϵ \vert {ω}^{′} , {α}^{′} , {β}^{′} ) - \\ {Q ( {p}_{t} , {{q}_{t}}^{⟶} \vert ω , α , β ) )}^{2}\end{matrix}$
    where Q(p, \vec{q}|ω, α, β) = A(p, \vec{q}|ω, α) + V(p|ω, β);
    using sample gradient policy to update action network:
    ${∇}_{{θ}_{i}} J ( {θ}_{i} ) \approx \frac{1}{d} {\sum }_{t = 1}^{d} {∇}_{{q}_{i}^{t}} Q ( {p}_{t} , \vec{{q}_{t}} \vert ω ) {∇}_{{θ}_{i}} μ ( {p}_{t} \vert {θ}_{i} ) ;$
    soft update target networks of action and valuation networks;
  end for
end for
```

In this embodiment, each drone j has an action network μ(p|θⱼ) with parameter θ, and shares an evaluation network Q(p, \vec{q}|ω, α, β) with parameter ω. At the beginning, the drone i interacts with the environment according to the policy θᵢ, returns the corresponding reward through the reward constraint based on the potential energy function, and stores the state transfer process in the experience playback buffer as the data set D, and randomly extracts experience to perform network updates to the evaluation network and action based on the policy gradient algorithm respectively.

What is claimed is:

1. A temporal equilibrium analysis-based multi-agent multi-task continuous control method, characterized in comprising the following steps:
S1, constructing a multi-agent multi-task game model based on temporal logic, performing temporal equilibrium analysis and synthesizing multi-agent top-level control policies;
S2, constructing a specification auto-completion mechanism, improving dependent task specification by adding environment assumptions;
S3, constructing connection mechanism between the top-level control policies and bottom-level deep deterministic policy gradient algorithms, and constructing multi-agent continuous task controllers based on the connection mechanism.

2. The temporal equilibrium analysis-based multi-agent multi-task continuous control method according to claim 1, characterized in that, in step S1, the constructed multi-agent multi-task game model is:
$$𝒢 = < N a , S , A , {S}_{0} , Tr , {λ ( {γ}_{i} )}_{i ∈ N} , ψ >$$
where, Na represents the agent set, S and A respectively represent the state set and action set of the game model, S₀ is the initial state, Tr∈S×\vec{A}→S represents the state transition function in which all agents in a single state s∈S transit to a next state by taking action set \vec{a}∈\vec{A}, \vec{A} represents a vector of the action sets of different agents; λ∈S→2^{AP} represents a labelling function from state to atomic proposition; (γᵢ)_{i∈N} represents the specification for each agent i; ψ represents the specification that needs to be completed by the overall system;
Constructing an infeasible region Rᵢ( [symbol] ) for each agent i, such that the agent i does not have tendency of deviating from the current policy set in the set in which Rᵢ( [symbol] ) is located, the infeasible region Rᵢ( [symbol] ) is expressed as follows:
$${R}_{i} ( 𝒢 ) = \{ s \vert ∃ \vec{σ} \cdot ∀ {σ}_{i} ⇒ π ( s , ( {\vec{σ}}_{- i} , {σ}_{i} ) ) \text{\vert ≠} {γ}_{i} \}$$
where, there exists a policy set \vec{σ} in Rᵢ( [symbol] ) such that all policies σᵢ and the combination of other policies (\vec{σ}₋ᵢ, σᵢ) of agent i cannot satisfy γᵢ. \vec{σ}₋ᵢ represents that the policy set does not include the policy combinations of the ith agent; “∃” represents “existence”; “ [symbol] ” represents “incompliance”;
then computing ∧_{i∈L} Rᵢ( [symbol] ), determining whether there exists a trajectory π in the intersection that satisfies (ψ∧∧_{i∈W} γᵢ), and using model-checking method to generate the top-level control policy for each agent.

3. The temporal equilibrium analysis-based multi-agent multi-task continuous control method according to claim 1, characterized in that, in step S2, the detailed steps of constructing the specification auto-completion mechanism are as follows:
S21, refining task specification by adding environment assumptions;
adding environment constraints Ψ of loser L by selecting ε∈E, automatically generate a new specification using an anti-policy mode, which is expressed as:
$${⋀}_{e = 1}^{m} GF {Ψ}_{e} ∧ ℰ ⇒ {⋀}_{f = 1}^{n} GF {φ}_{f}$$
where, E is the environment constraint set; m represents the number of assumed specification in the specification, n represents the number of guaranteed specification (≥ the number of subsequent GF); the value range of e is [1, m], and the value range of f is [1, n];
the detailed steps of generating the new specification are as follows:
S211, computing policies of the negated form of the original specification which acts as policies of finite state automata format for systhesizing (∧ₑ₌₁^{m} GF Ψₑ)∧¬(∧_{f=1}ⁿ GF φ_{f}); G represents that the specification is always true from the current moment; F represents that the specification will be eventually true at certain moment in the future;
S212, designing a pattern on the finite state automata that satisfies the form of FG Ψₑ specification;
S213, generating a specification according to the generated pattern and perform negation;
S22, for a task of a first agent M⊆W which is dependent on a task of a second agent N⊆W, under the condition of temporal equilibrium, firstly computing policies for all agents through Rᵢ( [symbol] ), synthesizing the finite state automata format; then designing patterns which satisfy the form of FG Ψₑ based on policies and using the pattern to generate ε^{a′}; searching specification refinement set ε^{b} of all agents b∈M according to step S21;
then determining whether all of the specification satisfy ε^{s′}⇒ε^{b}; if satisfied, completing the refinement of task specification with dependency; if not satisfied, iteratively constructing ε^{a′} and ε^{b} until the following formula are satisfied:
$$\{ \begin{matrix}{∧}_{e = 1}^{m} G F {Ψ}_{e}^{k 1} ⇒ {∧}_{f = 1}^{n} GF {φ}_{f}^{k 1} , k 1 ∈ N \\ {∧}_{e = 1}^{m} G F {Ψ}_{e}^{k 2} ⇒ {∧}_{f = 1}^{n} GF {φ}_{f}^{k 2} , k 2 ∈ M\end{matrix} ⟹ \{ \begin{matrix}{∧}_{e = 1}^{m} G F {Ψ}_{e}^{k 1} ⇒ {∧}_{f = 1}^{n} GF {φ}_{f}^{k 1} ∧ {ℰ}^{k ′} , k 1 ∈ N \\ {∧}_{e = 1}^{m} G F {Ψ}_{e}^{k 2} ∧ {ℰ}^{k} ⇒ {∧}_{f = 1}^{n} GF {φ}_{f}^{k 2} , k 2 ∈ M \\ ∀ a , b \cdot a ∈ N ∧ b ∈ M ⇒ ( {ℰ}^{a ′} ⇒ {ℰ}^{b} )\end{matrix}$$
where, W represents the set of agents that can satisfy the specification; ∧ₑ₌₁^{m} GF Ψₑ^{k1} represents the e-th assumed specification of agent k1 in the second agent set N; ∧_{f=1}ⁿ GF φ_{f}^{k1} represents the f-th guaranteed specification of agent k1 in the second agent set N; ∧ₑ₌₁^{m} GF Ψₑ^{k2} represents the e-th assumed specification of the agent k2 in the second agent set M; ∧_{f=1}ⁿ GF φ_{f}^{k2} represents the f-th guarantee rule of agent k2 in the second agent set M.

4. The temporal equilibrium analysis-based multi-agent multi-task continuous control method according to claim 3, characterized in that, further comprising: in the case that new specification is generated, determining whether the specification of all agents are reasonable and realizable after adding environment assumptions:
if realizable, completing the refinement of specification;
if ∧ₑ₌₁^{m} GF Ψₑ∧ε is reasonable, but there are situations where the specification cannot be realized by the agent after adding environment assumptions, iteratively constructing ε′, such that ∧ₑ₌₁^{m} GF Ψₑ∧ε∧ε′ can be realized.

5. The temporal equilibrium analysis-based multi-agent multi-task continuous control method according to claim 1, characterized in that, in step S3, the detailed steps of constructing the connection mechanism between the top-level control policies and bottom-level deep deterministic policy gradient algorithms, and constructing multi-agent continuous task controllers based on the connection mechanism are as follows:
S31, according to temporal equilibrium analysis, acquiring policy σᵢ=<Uᵢ, uᵢ⁰, Fᵢ, ACᵢ, δᵢ^{u}, δᵢ^{a}> needed of each agent in the game model, expanding the acquired policy as ηᵢ=<Uᵢ, uᵢ⁰, Fᵢ, ACᵢ, δᵢ^{u}, δᵢ^{r}>, where δᵢ^{r}∈Uᵢ×2^{AP}→R, and using it as a reward function in the expanded Markov decision process in a multi-agent environment; the expression of the expanded Markov decision process in a multi-agent environment is as follows:
$$T = < N a , P , Q , h , ζ , ℒ , < {η}_{i} {>}_{i ∈ N} >$$
where, Na represents the agent set, P and Q respectively represent the environment states and action set taken by the multi-agent, h represents probability of state transition; ζ represents attenuation coefficient of T; [symbol] ∈P×Q×P→2^{AP} represents labelling function for state transition to atomic propositions, ηᵢ represents benefit that the environment obtains when adopting policy of agent i, transferring to p′∈P after agent i taking action q∈Q in p∈P, its state on ηᵢ will also transfer from u∈Uᵢ∪Fᵢ to u′=δᵢ^{u}(u, [symbol] (p, q, p′)) and obtain the reward δᵢ^{r}(u, [symbol] (p, q, p′)); “<>” represents a tuple, “∪” represents a union;
S32, expanding ηᵢ to Markov decision process format with the attenuation function ζᵣ determined by the state transition, and initializing all δᵢ^{r}, so that δᵢ^{r} is 0 when δᵢ^{u}(u, [symbol] (p, q, p′))∉F; δᵢ^{r} is 1 when δᵢ^{u}(u, [symbol] (p, q, p′))∈F; then determining the value function v(u)* of each state through the value iteration method, and adding the converged v(u)* to the reward function as a potential energy function, wherein the reward function r(p, q, p′) of T is expressed as follows:
$${r}^{′} ( p , q , {p}^{′} ) = r ( p , q , {p}^{′} ) + {ζ}_{r} ( {v ( {δ}_{i}^{u} ( u , ℒ ( p , q , {p}^{′} ) ) )}^{*} ) - {v ( u )}^{*}$$
S33, each agent i has an action network μ(p|θᵢ) with parameters θ, and shares an evaluation network Q(p, \vec{q}|ω, α, β) with parameters ω; constructing a loss function J(ω) for the evaluation network parameter ω, and updating the network according to the gradient backpropagation of the network. The expression of the loss function J(ω) is as follows:
$$J ( ω ) = \frac{1}{d} {\sum }_{t = 1}^{d} {( {r}_{t} + ζ {Q}^{′} ( {p}_{t + 1} , {{q}_{t + 1}}^{⟶} + ϵ \vert {ω}^{′} , {α}^{′} , {β}^{′} ) - Q ( {p}_{t} , \vec{{q}_{t}} \vert ω , α , β ) )}^{2}$$
where, rₜ is the reward value computed in step S32, Q(p, \vec{q}|ω, α, β)=A(p, \vec{q}|ω, α)+V(p|ω, β), A(p, \vec{q}|ω, α) and V(p|ω, β) are designed as fully connected layer networks to evaluate the state value and action advantage respectively. α and β are the parameters of the two networks respectively; d is randomly sampled data from experience playback buffer data set D;
finally soft-updating the target evaluation network parameter and action network parameters respectively according to the evaluation network parameters ω and action network parameters θᵢ.

6. The temporal equilibrium analysis-based multi-agent multi-task continuous control method according to claim 5, characterized in that, when the hetero-policy algorithm is used for gradient update, estimating the expected value of [symbol] Q·∇_{θ}_{ᵢ}μ according to the Monte Carlo method, and substituting the randomly sampled data into the following formula to perform unbiased estimation:
$${∇}_{{θ}_{i}} J ( {θ}_{i} ) \approx \frac{1}{d} {\sum }_{t = 1}^{d} {∇}_{{q}_{i}^{t}} Q ( {p}_{t} , \vec{{q}_{t}} \vert ω ) {∇}_{{θ}_{i}} μ ( {p}_{t} \vert {θ}_{i} )$$
where, ∇ represents the differential operator.
